(19) United States
(12) Patent Application Publication
(10) Pub. No.: US 2020/0329451 A1
(43) Pub. Date: Oct. 15, 2020

(54) GPS Tracking Device with Artificial Intelligence and Geo-Fencing

(71) Applicant: Hooria Omar, Ajax (CA)

(72) Inventor: Hooria Omar, Ajax (CA)

(21) Appl. No.: 16/827,206

(22) Filed: Mar. 23, 2020

Related U.S. Application Data
(60) Provisional application No. 62/831,191, filed on Apr. 9, 2019.

(51) Int. Cl. H04W 64/00; G01S 19/24; H04W 4/021

(52) U.S. Cl. CPC H04W 64/003; H04W 4/021; G01S 19/24

(57) ABSTRACT

An apparatus of a tracking system employing a global positioning system (GPS) for determining the location of one or more objects is disclosed. The tracking system can receive position data from a user equipment. The tracking system can send the position data via a transmitter, to a satellite of the GPS. The tracking system can receive one or more signals from the GPS via a positioning sensor, wherein the one or more signals facilitate searching locating, and acquiring location data for the one or more objects. The tracking system can obtain boundary information from the user equipment defining a restricted area. The tracking system can determine a current position of the one or more objects in relation to the boundary information. The tracking system can send an alert message to the user equipment as a result of the determination that the one or more objects have entered the restricted area.

### CROSS REFERENCE TO RELATED APPLICATIONS

This application claims benefit under 35 U.S.C. 119 of U.S. Provisional Application No. 62/831,191, filed Apr. 9, 2019

### FIELD OF THE INVENTION

Example embodiments relate generally to a Global Positioning System (GPS) tracking device. Specifically, the GPS device can be operable to include artificial intelligence (AI) and Geo Fencing. The device can be placed on a person or object, set a specific path, and set no-go zones.

### BACKGROUND

This invention relates generally to navigation systems and more specifically to a system for positioning radiosondes, sonobuoys, aircraft, ships, land vehicles, and other objects on or near the earth's surface using satellites of the Global Positioning System (GPS). The GPS is a multiple-satellite based radio positioning system in which each GPS satellite transmits data that allows a user to precisely measure the distance from selected ones of the GPS satellites to his antenna and to thereafter compute position, velocity, and time parameters to a high degree of accuracy, using known triangulation techniques. The signals provided by the GPS can be received both globally and continuously.

GPS is intended to be used in a wide variety of applications, including space, air, sea, and land object navigation, precise positioning, time transfer, attitude reference, surveying, etc. GPS will be used by a variety of civilian and military organizations all over the world. A number of prior art GPS receivers have been developed to meet the needs of the diverse group of users. These prior art GPS receivers are of a number of different types, including sequential tracking, continuous reception, multiplex, all in view, time transfer, and surveying receivers.

In many instances, GPS systems have become more advanced where they are wearable and able to more precisely pinpoint the location of an object, or person in possession of the GPS system in more precise details. The more precise details can be within a local area, in a warehouse, or within a building with its own centrally positioned GPS system.

The navigation processing and memory functions performed by a typical GPS receiver include satellite orbit calculations and satellite selection, atmospheric delay correction calculations, navigation solution computation, clock bias and rate estimates, computation of output information, and preprocessing and coordinate conversion of aiding information, for example. These functions require significant amounts of processing and memory and are generally performed using a floating point coprocessor.

Current tracking devices can pinpoint a GPS coordinate of the device but does not inform the user before it is out of reach or going in the wrong location. As such, there is not a device that consistently sends updates of where the device is held or if it moves out of one or more marked locations. Furthermore, there is a lack of artificial intelligence integrated in the existing systems.

As such, none of the art described above addresses all the issues that the embodiments of the present invention do.

### SUMMARY OF THE INVENTION

In order to resolve many of the aforementioned problems, one skilled in the art would appreciate a solution that the GPS tracking device with AI and Geo Fencing discloses. It is therefore the principal object of the present invention to provide a solution to the above described problem(s) by providing a GPS tracking device that has Artificial Intelligence (AI) and Geo Fencing into both the device, and cloud database. With the data gathered about the device's daily routine pattern, this allows it to become “SMART” and basically identify when the device is off its regular pattern and will always be connected to the user's mobile device to notify the end user.

Accordingly, the proposed invention is a GPS tracking device that comprises of Artificial Intelligence (AI) and Geo Fencing. The device may be placed on a person or object and set a specific path and no-go zones. When the carrier strays from a path or visits a geo-fenced area, the system sends an alert to the end user. The system connects to an end user's cellphone through an application.

In one aspect of the invention an apparatus of a tracking system employing a global positioning system (GPS) for determining the location of one or more objects is disclosed. The tracking system can receive position data from a user equipment. The tracking system can send the position data via a transmitter, to a satellite of the GPS. The tracking system can receive one or more signals from the GPS via a positioning sensor, wherein the one or more signals facilitate searching locating, and acquiring location data for the one or more objects. The tracking system can obtain boundary information from the user equipment defining a restricted area. The tracking system can determine a current position of the one or more objects in relation to the boundary information. The tracking system can send an alert message to the user equipment as a result of the determination that the one or more objects have entered the restricted area.

In one embodiment, an apparatus of the tracking system is configured to be attached to the one or more objects.

In one embodiment, the one or more objects is one or more of a person, a pet, an animal, a child, a bag, or an electronic device.

In one embodiment, the restricted area is configured with geo-fencing.

In one embodiment, the boundary information is configured to comprise of one or more of a path, walking area, directions, or a danger area.

In one embodiment, the user equipment is one or more of a tablet, a mobile phone, a laptop, or a personal digital assistant (PDA).

In one embodiment, the alert is one or more of a sound, a verbal warning, a call, a text message, or a vibration.

In addition to the foregoing, other objects, features, aspects and advantages of the present invention will be better comprehended through a careful reading of a detailed description provided herein below with appropriate reference to the accompanying drawings.

This Summary is provided merely for purposes of summarizing some example embodiments, so as to provide a basic understanding of some aspects of the subject matter described herein.

Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF DRAWINGS

The accompanying figures are included to provide a further understanding of the invention, and are incorporated in and constitute a part of this specification. The figures illustrate embodiments of the invention and, together with the description, serve to explain the principles of the invention.

The foregoing and other objects, aspects, features, and advantages of the disclosure will become more apparent and better understood by referring to the following description taken in conjunction with the accompanying drawings, in which:

FIG. 1 depicts a top and bottom view of the GPS tracking device, in accordance with an embodiment of the present invention;

FIG. 2 depicts an example of the artificial intelligence and geo-fencing tracking abilities, in accordance with an embodiment of the present invention;

FIG. 3 depicts an example of the device clipped onto a belt, in accordance with an embodiment of the present invention; and

FIG. 4 depicts an example of the device clipped onto a backpack in accordance with an embodiment of the present invention.

### REFERENCE NUMERALS IN DRAWINGS

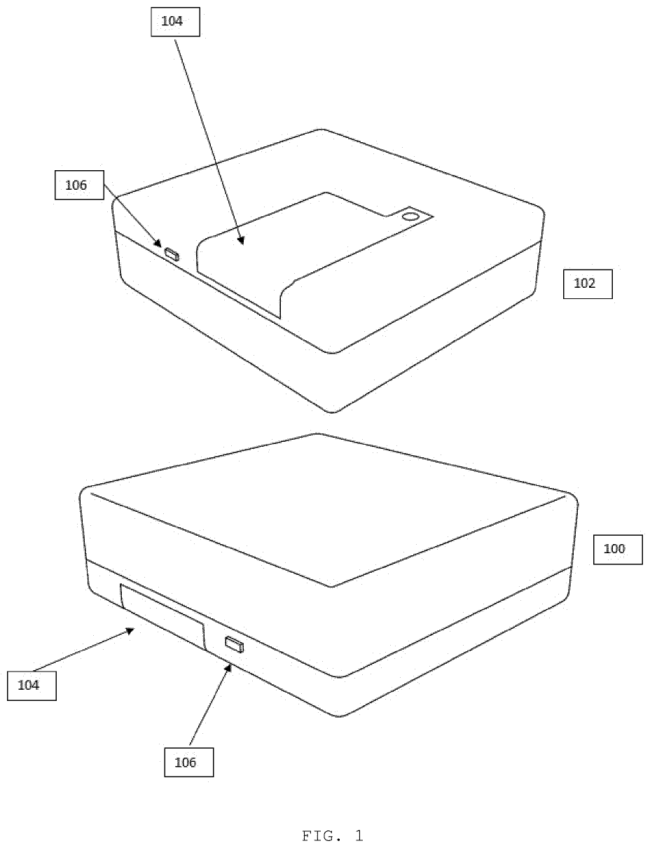

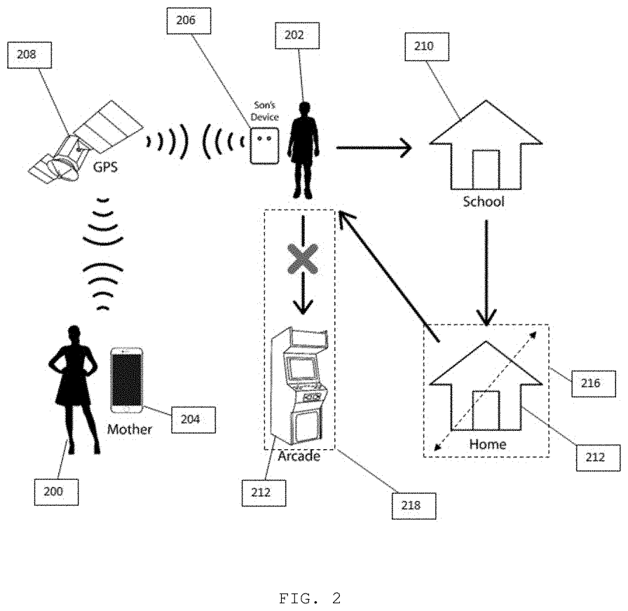

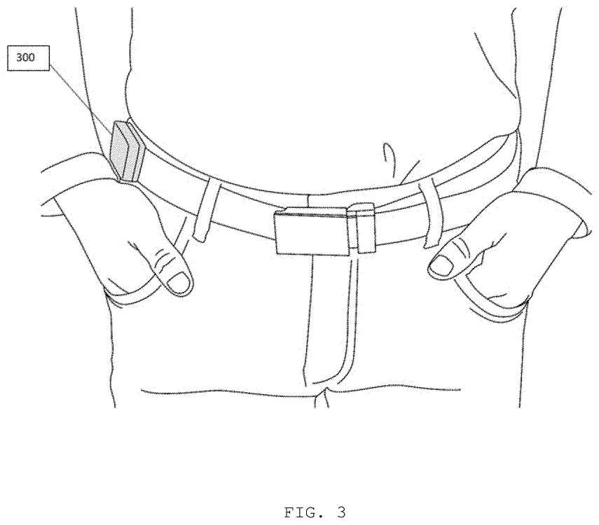

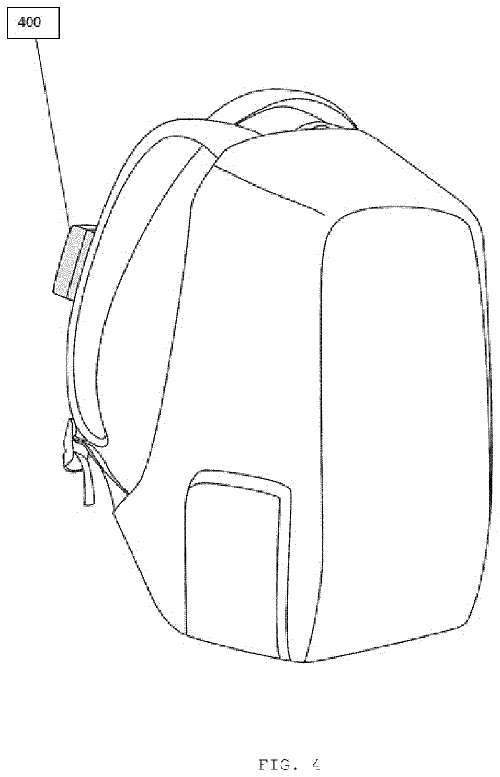

100 Top Isometric View of Device (FIG. 1)
102 Bottom Isometric View of Device (FIG. 1)
104 Cover on device Body (FIG. 1)
106 Button on Device Body (FIG. 1)
200 Mother in Example (FIG. 2)
202 Son in Example (FIG. 2)
204 Cellphone (FIG. 2)
206 Proposed Invention GPS Tracking Device (FIG. 2)
208 GPS Network (FIG. 2)
210 School in Example (FIG. 2)
212 Home in Example (FIG. 2)
214 Arcade in Example (FIG. 2)
216 Restricted Area in GPS (FIG. 2)
218 Geo-Fenced Area (FIG. 2)
300 Proposed Invention GPS Tracking Device (FIG. 3)
400 Proposed Invention GPS Tracking Device (FIG. 4)

### DETAILED DESCRIPTION

Some detailed example embodiments are disclosed herein. However, specific structural and functional details disclosed herein are merely representative for purposes of describing example embodiments. Example embodiments may, however, be embodied in many alternate forms and should not be construed as limited to only the embodiments set forth herein.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but to the contrary, example embodiments are to cover all modifications, equivalents, and alternatives falling within the scope of example embodiments. Like numbers refer to like elements throughout the description of the figures.

It should be understood that when an element or layer is referred to as being “on,” “connected to,” “coupled to,” or “covering” another element or layer, it may be directly on, connected to, coupled to, or covering the other element or layer or intervening elements or layers may be present. In contrast, when an element is referred to as being “directly on,” “directly connected to,” or “directly coupled to” another element or layer, there are no intervening elements or layers present. Like numbers refer to like elements throughout the specification. As used herein, the term “and/or” includes any and all combinations of one or more of the associated listed items.

It should be understood that, although the terms first, second, third, etc. may be used herein to describe various elements, items, regions, layers and/or sections, these elements, items, regions, layers, and/or sections should not be limited by these terms. These terms are only used to distinguish one element, item, region, layer, or section from another region, layer, or section. Thus, a first element, item, region, layer, or section discussed below could be termed a second element, item, region, layer, or section without departing from the teachings of example embodiments.

Spatially relative terms (e.g., “beneath,” “below,” “lower,” “above,” “upper,” and the like) may be used herein for ease of description to describe one element or feature's relationship to another element(s) or feature(s) as illustrated in the figures. It should be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” may encompass both an orientation of above and below. The device may be otherwise oriented (rotated 90 degrees or at other orientations) and the spatially relative descriptors used herein interpreted accordingly.

The terminology used herein is for the purpose of describing various embodiments only and is not intended to be limiting of example embodiments. As used herein, the singular forms “a,” “an,” and “the” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or items, but do not preclude the presence or addition of one or more other features, integers, steps, operations, elements, items, and/or groups thereof.

Example embodiments are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments should not be construed as limited to the shapes of regions illustrated herein but are to include deviations in shapes that result, for example, from manufacturing. Thus, the regions illustrated in the figures are schematic in nature and their shapes are not intended to illustrate the actual shape of a region of a device and are not intended to limit the scope of example embodiments.

Unless otherwise defined, all terms (including technical and scientific terms) used herein have the same meaning as commonly understood by one of ordinary skill in the art to which example embodiments belong. It will be further understood that terms, including those defined in commonly used dictionaries, should be interpreted as having a meaning that is consistent with their meaning in the context of the relevant art and will not be interpreted in an idealized or overly formal sense unless expressly so defined herein.

The detailed description set forth below in connection with the appended drawings is intended as a description of the presently contemplated embodiments of the GPS tracking systems, and is not intended to represent the only form in which the disclosed invention may be developed or utilized. The description sets forth the various functions and features in connection with the illustrated embodiments. It is to be understood, however, that the same or equivalent functions may be accomplished by different embodiments that are also intended to be encompassed within the scope of the present disclosure. It is further understood that the use of relational terms such as first and second, top and bottom and the like are used solely to distinguish one from another entity without necessarily requiring or implying any actual such relationship or order between such entities. All the terminologies and techniques mentioned herein are not particular to any specific embodiment, and it does not scale down different personifications of our invention. Use of words like “and/or” herein includes all the associated listed items and holds all the combinations of different embodiments. Use of singular form of words like “a/an/the” also associate their plural forms into the context unless otherwise clearly defined for their singular meaning.

All the scientific and technical terms used in this document should be subjected to general understandings of the one with ordinary skills in the field of the invention unless otherwise defined prior. A further understanding is also required to interpret all the terms from the commonly used dictionary reference to the consistency in the contextual background rather than their literal meanings that can create confusion between their idealized and subjective meanings.

The preferred embodiments of the present invention will now be described with reference to the drawings. Identical elements in the various figures are identified with the same reference numerals.

Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

FIG. 1 is an illustrative representation showing a line drawn depiction of the top and bottom view of the GPS tracking device in accordance with an embodiment of the present invention. This depiction shows the body of the device and its outside features. The top of the device (100) and bottom of device (102) are shown in this depiction. In some examples, the bottom of the device can be configured to have a securing means, which allows the device to be placed or connected on an object or person. The securing means can be one or more of a clip, a hook and loop fastener, or double sided tape.

The device also features a cover (104) which may house electronics as well as batteries. The cover 104 can be configured to hold at least one battery, and in some examples two, wherein a first battery is for the main power source, and a second battery is used as a backup. The system can be configured to monitor the battery level of the battery and indicate when either of the batteries are in a lower power state. Additionally, the system can implore various battery saving techniques where a “Sleep mode” or “power saver” mode or “standby” mode can be utilized to maximize the power available in either the first battery or a second battery.

The device can be configured with one or more buttons (106). The one or more buttons can comprise of one or more of a power on/off switch, a mode switch, a tracking activation switch, or a settings button. The settings can comprise of one or more of restriction zone setup, Bluetooth setup, or a messaging capability to communicate with one or more user equipments (UEs). In one embodiment, the casing and the cover 104 are configured to be waterproof and damp proof.

FIG. 2 is an illustrative representation showing a diagram of the artificial intelligence and geo-fencing tracking abilities in accordance with an embodiment of the present invention. This diagram and description will explain the aspect of the geo-tracking system with memorization using artificial intelligence. The example uses a mother (200) and son (202) as an example of user and end user. The mother can use a cellphone (204) with a web-based application to connect to the GPS device (proposed invention) (206) that is worn by the son. The GPS device connects to a GPS network (208) and provides a coordinate of the device's location at specific intervals. The current invention is similar to traditional GPS devices and these mechanics, but the specific way the current invention operates provides the difference to existing inventions.

In some embodiments, the tracking user or mother 200 can set the boundary information of the tracking device or GPS device worn by the son 202. In some examples, the boundary information can be dynamically adjusted based off of preset materials, police reports, danger alerts, traffic patterns, and normal routes taken by the son 202. The mother 200 can adjust the boundary information based on predetermined activities, or an additional allowed route, or location of access for the son 202.

Accordingly, the device is able to learn the pattern of the user wearing it. For example, if the son is wearing the device and has a route to travel to school (210), then back home (212) after school every day, the device is able to memorize and recognize it every time the son walks to school and home. If the child decides to go to the arcade (214) instead of school, the device notifies the mothers cellphone with a push notification. The device can also geo-fence a specific area (216) or a distance radius (218) from a specific location, therefore making it trigger an alert on the cellphone.

FIG. 3 is an illustrative representation of the device clipped onto a belt in accordance with an embodiment of the present invention. This depiction provides an example of a user wearing the GPS tracking device (300) on their belt strap. The device may attach with a clip or other method. In a preferred embodiment, the device can be constructed to be small enough to fit on a user's belt in the front, back or on the sides, positioned as to not impede on the wearer's comfort.

FIG. 4 is an illustrative representation showing the device clipped onto a backpack in accordance with an embodiment of the present invention. This depiction provides an example of the GPS tracking device (400) attached to a backpack strap. The device may attach with a clip, hook and loop fastener, or other similar securing method. In an alternative example, the device may be placed inside of the backpack, a pocket, a jacket, or another secured location that is attached or worn on a user's body, and does not have to clip on. The device may also be put into other valuables such as a car, motorcycle or suitcase at the airport.

Example embodiments having thus been described, it will be obvious that the same may be varied in many ways. Such variations are not to be regarded as a departure from the intended spirit and scope of example embodiments, and all such modifications as would be obvious to one skilled in the art are intended to be included within the scope of the following claims.

Although the present invention has been described in terms of various embodiments, it is not intended that the invention be limited to these embodiments. Modification within the spirit of the invention will be apparent to those skilled in the art.

What is claimed is:

1. An apparatus of a tracking system employing a global positioning system (GPS) for determining the location of one or more objects, the tracking system is configured to:
receive position data from a user equipment;
send the position data via a transmitter, to a satellite of the GPS;
receive one or more signals from the GPS via a positioning sensor, wherein the one or more signals facilitate searching locating, and acquiring location data for the one or more objects;
obtain boundary information from the user equipment defining a restricted area;
determine a current position of the one or more objects in relation to the boundary information; and
send an alert message to the user equipment as a result of the determination that the one or more objects have entered the restricted area.

2. The apparatus of claim 1 further configured to be attached to the one or more objects.

3. The apparatus of claim 1, wherein the one or more objects is one or more of a person, a pet, an animal, a child, a bag, or an electronic device.

4. The apparatus of claim 1, wherein the restricted area is configured with geo-fencing.

5. The apparatus of claim 1, wherein the boundary information is configured to comprise of one or more of a path, walking area, directions, or a danger area.

6. The apparatus of claim 1, wherein the user equipment is one or more of a tablet, a mobile phone, a laptop, or a personal digital assistant (PDA).

7. The apparatus of claim 1, wherein the alert is one or more of a sound, a verbal warning, a call, a text message, or a vibration.
